(19) United States
(12) Patent Application Publication
(10) Pub. No.: US 2024/0013032 A1
(43) Pub. Date: Jan. 11, 2024

(54) BINARY NEURAL NETWORKS WITH GENERALIZED ACTIVATION FUNCTIONS

(71) Applicant: CARNEGIE MELLON UNIVERSITY, Pittsburgh, PA (US)

(72) Inventors: Zhiqiang Shen, Pittsburgh, PA (US); Zechun Liu, Pittsburgh, PA (US); Marios Savvides, Wexford, PA (US)

(21) Appl. No.: 18/008,237

(22) PCT Filed: Jan. 25, 2022
(86) PCT No.: PCT/US22/13680

§ 371 Date: Dec. 5, 2022

Related U.S. Application Data
(60) Provisional application No. 63/146,758, filed on Feb. 8, 2021.

(51) Int. Cl. G06N 3/0464; G06N 3/084

(52) U.S. Cl. CPC G06N 3/0464; G06N 3/084

(57) ABSTRACT

Disclosed herein is a design for a 1-bit CNN that closes the performance gap between binary neural networks and real-valued networks on challenging large-scale datasets. The design starts with a high-performance baseline network. Blocks with identity shortcuts which bypass 1-bit generic convolutions are adopted to replace the convolutions in the baseline network. Reshaping and shifting of activation functions is introduced. Finally, a distributional loss to further is adopted enforce the binary network to learn similar output distributions as those of a real-valued network.

### RELATED APPLICATIONS

This application is a national phase filing under 35 U.S.C. § 371 claiming the benefit of and priority to International Patent Application No. PCT/US22/13680, filed Jan. 25, 2022, entitled “Binary Neural Networks with Generalized Activation Functions,” which claims the benefit of U.S. Provisional Patent Application No. 63/146,758, filed Feb. 8, 2021, the contents of which are incorporated herein their entireties.

### BACKGROUND

The 1-bit convolutional neural network (1-bit CNN, also known as binary neural network), wherein both weights and activations are binary, is one of the most promising neural network compression methods for deploying models onto resource-limited devices. It enjoys 32× memory compression ratio, and up to 58× practical computational reduction. Moreover, with its pure logical computation (i.e., XNOR operations between binary weights and binary activations), the 1-bit CNN is both highly energy-efficient for embedded devices and possesses the potential of being directly deployed on next generation memristor-based hardware.

Despite these attractive characteristics of 1-bit CNN, severe accuracy degradation prevents it from being broadly deployed. For example, a representative binary network, XNOR-Net only achieves 51.2% accuracy on the ImageNet classification dataset, leaving an 18% accuracy gap from the real-valued ResNet-18. Some preeminent binary networks show good performance on small datasets such as CIFAR10 and MNIST, but still encounter severe accuracy drop when applied to a large dataset such as ImageNet. Therefore, it is desirable to provide a design for a 1-bit CNN that improves its accuracy, while preserving the characteristics that make it attractive for deployment on resource-limited devices.

### SUMMARY

Disclosed herein is a design for a 1-bit CNN that closes the performance gap between binary neural networks and real-valued networks on challenging large-scale datasets. The invention starts with a design for a high-performance baseline network. In one embodiment, MobileNetV1 is chosen as the binarization backbone, although in other embodiments, any binary backbone may be used. Next, the invention adopts blocks with identity shortcuts which bypass 1-bit generic convolutions to replace the convolutions in MobileNetV1. Moreover, the invention uses a concatenation of two of such blocks to handle the channel number mismatch in the downsampling layers, as shown in FIG. 1(a). This baseline network design not only avoids real-valued convolutions in shortcuts, which effectively reduces the computation to near half of that needed in prevalent binary neural networks, but also achieves a high top-1 accuracy on ImageNet.

To further enhance the accuracy, the invention introduces activation distribution reshaping and shifting via non-linearity function design. The overall activation value distribution affects the feature representation, and this effect will be exaggerated by the activation binarization. A small distribution value shift near zero will cause the binarized feature map to have a disparate appearance which influences the final accuracy. This achieved by a new generalization of the Sign and PReLU functions which explicitly shift and reshape the activation distribution, referred to herein as ReAct-Sign (RSign) and ReAct-PReLU (RPReLU) respectively. These novel activation functions adaptively learn the parameters for distributional reshaping, which enhance the accuracy of the baseline network with negligible extra computational cost.

Furthermore, the invention introduces a distributional loss to enforce the output distribution similarity between the binary and real-valued networks, which further boosts the accuracy.

The novel aspects of the invention can be summarized as follows: (1) a baseline binary network is provided as a modification of MobileNetV1; (2) a channel-wise reshaping and shifting operation on the activation distribution, which helps binary convolutions spare the computational power in adjusting the distribution to learn more representative features; and (3) a distributional loss between binary and real-valued network outputs, replacing the original loss, which allows the binary network to mimic the distribution of a real-valued network.

### BRIEF DESCRIPTION OF THE DRAWINGS

By way of example, a specific exemplary embodiment of the disclosed system and method will now be described, with reference to the accompanying drawings, in which:

FIG. 1 is a block diagram showing the baseline network block and the ReActNet block introduced herein.

FIG. 2 is an illustration of how distribution shift affects feature learning in binary neural networks, showing an ill-shifted distribution will introduce (a) too much background noise or (c) too few useful features, which harms feature learning.

FIG. 3 are graphs showing the novel activation functions RSign (a) and RPReLU (b), contrasted with traditional activation functions.

FIG. 4 is a visualization of the operation of the RPReLU activation function.

### DETAILED DESCRIPTION

In a 1-bit convolutional layer, both weights and activations are binarized to −1 and +1, such that the computationally heavy operations of floating-point matrix multiplication can be replaced by light-weighted bitwise XNOR operations and popcount operations, as:

χ_{b}* [symbol] _{b}=popcount(XNOR(χ_{b}, [symbol] _{b})) (1)

where:
[symbol] _{b} indicates the matrix of binary weights; and
χ_{b} indicates the matrix of binary activations.

Specifically, weights and activations are binarized through a Sign function:

$${x}_{b} = Sign ( {x}_{r} ) = \{ \begin{matrix}+ 1 , if {x}_{r} > 0 \\ - 1 , if {x}_{r} \leq 0\end{matrix} \\ {b}_{} = \frac{{‖ {r}_{} ‖}_{l 1}}{n} Sign ( {r}_{} ) = \{ \begin{matrix}+ \frac{{‖ {r}_{} ‖}_{l 1}}{n} , if {r}_{} > 0 \\ - \frac{{‖ {r}_{} ‖}_{l 1}}{n} , if {r}_{} \leq 0\end{matrix} \qquad ( 2 )$$

where:
b and r denote binary and real values, respectively; and

$$\frac{{‖ {𝓌}_{r} ‖}_{l 1}}{n}$$

is the average of absolute weight values, used as a scaling factor to minimize the difference between binary and real-valued weights.

Note that with the introduction of the novel ReAct operations, discussed below, this scaling factor for activations becomes unnecessary and can be eliminated.

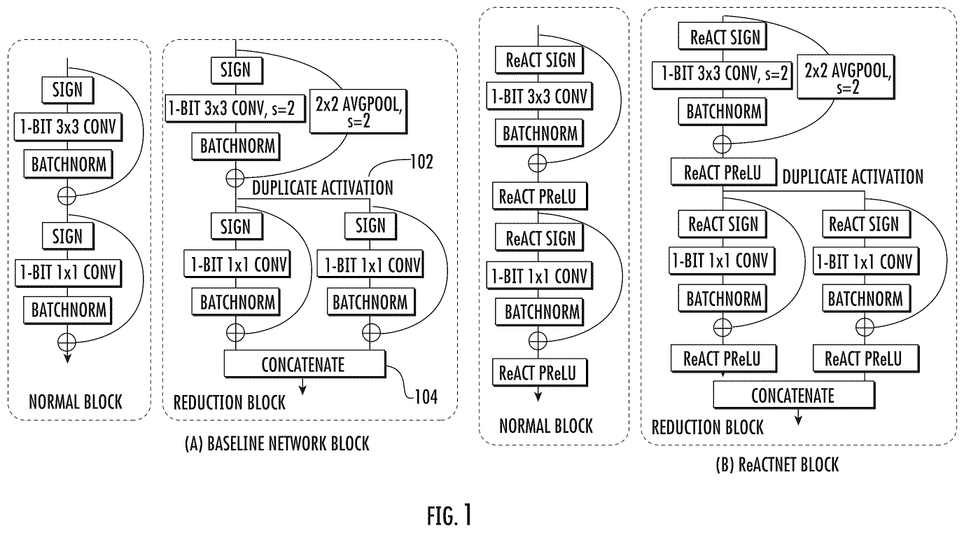

Baseline Network—In a primary embodiment, the MobileNetV1 structure is chosen for constructing the baseline binary network. A shortcut is added to bypass every 1-bit convolutional layer that has the same number of input and output channels. The 3×3 depth-wise and the 1×1 point-wise convolutional blocks in MobileNetV1 are replaced by the 3×3 and 1×1 generic convolutions in parallel with shortcuts, respectively, as shown in FIG. 1(a).

Additionally, a new structure design to handle the downsampling layers is provided. For the downsampling layers whose input and output feature map sizes differ, prior art works adopt real-valued convolutional layers to match their dimension and to make sure the real-valued feature map propagating along the shortcut will not be “cut off” by the activation binarization. However, this strategy increases the computational cost. Instead, the present invention ensures that all convolutional layers have the same input and output dimensions such that they can be safely binarized and uses a simple identity shortcut for activation propagation without additional real-valued matrix multiplications.

As shown in FIG. 1(a), input channels are duplicated 102 and two blocks with the same inputs are concatenated 104 to address the channel number difference. Also, average pooling is used in the shortcut to match spatial downsampling. All layers in the baseline network are binarized, except the first input convolutional layer and the output fully-connected layer. Such a structure is hardware friendly.

As shown in FIG. 1(a), the baseline configuration in terms of channel and layer numbers is identical to that of MobileNetV1. If the input and output channel numbers are equal in a dw-pw-conv pair in the original network, a normal block is used, otherwise a reduction block is adopted. For the reduction block, the input activation is duplicated and the outputs are concatenated to increase the channel number. As a result, all 1-bit convolutions have the same input and output channel numbers and are bypassed by identity short-cuts.

ReActNet—The intrinsic property of an image classification neural network is to learn a mapping from input images to the output logits. A logical deduction is that a good performing binary neural network should learn similar logits distribution as a real-valued network. However, the discrete values of variables limit binary neural networks from learning as rich distributional representations as real-valued ones. To address it, XNOR-Net calculates analytical real-valued scaling factors and multiplies them with the activations. These factors may be learned through back-propagation.

In contrast to these previous works, the present invention focuses on a different aspect: the activation distribution. Small variations to activation distributions can greatly affect the semantic feature representations in 1-bit CNNs, which, in turn, will influence the final performance. However, 1-bit CNNs have limited capacity to learn appropriate activation distributions. To address this dilemma, generalized activation functions are introduced with learnable coefficients to increase the flexibility of 1-bit CNNs for learning semantically-optimized distributions.

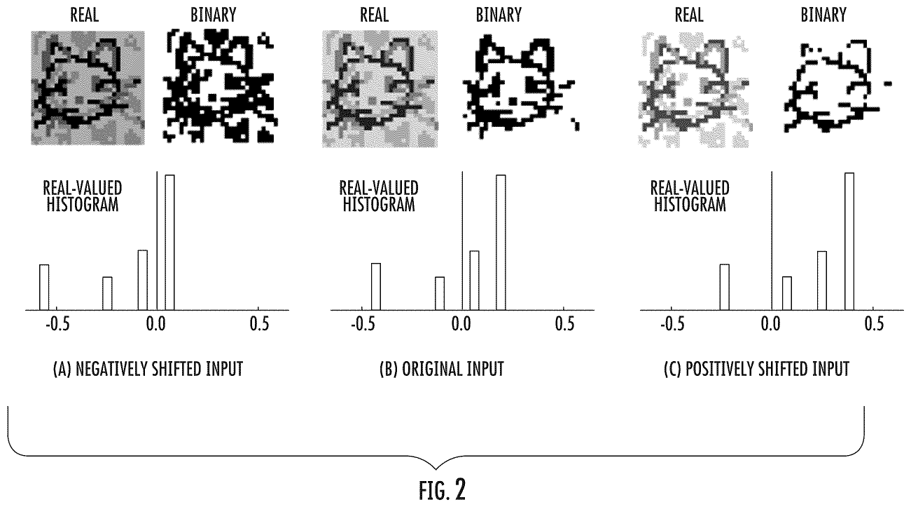

For 1-bit CNNs, learning distribution is both crucial and difficult. Because the activations in a binary convolution can only choose values from {−1, +1}, making a small distributional shift in the input real-valued feature map before the sign function can result in a completely different output binary activations, which will directly affect the informativeness in the feature and significantly impact the final accuracy. For illustration, the output binary feature maps of real-valued inputs are plotted, with the original (shown in FIG. 2(b)), positively-shifted (shown in FIG. 2(a)), and negatively-shifted (shown in FIG. 2(c)) activation distributions. Real-valued feature maps are robust to the shifts with which the legibility of semantic information will pretty much be maintained, while binary feature maps are sensitive to these shifts as illustrated in FIGS. 2(a) and 2(c). An ill-shifted distribution will introduce too much background noise (FIG. 2(a)) or too few useful features (FIG. 2(c)), which harms feature learning.

Based on the aforementioned observation, disclosed herein is an effective operation to explicitly reshape and shift the activation distributions, referred to herein as “ReAct”, which generalizes the traditional Sign and PReL U activation functions to ReAct-Sign (“Rsign”) and ReAct-PReLU (“RPReLU”) respectively.

Essentially, RSign is defined as a Sign function with channel-wise learnable thresholds:

$${x}_{i}^{b} = h ( {x}_{i}^{r} ) = \{ \begin{matrix}+ 1 , if {x}_{i}^{r} > {α}_{i} \\ - 1 , if {x}_{i}^{r} \leq {α}_{i}\end{matrix} \qquad ( 3 )$$

where:
xᵢ^{r} is a real-valued input of the RSign function h on the i^{th} channel;
xᵢ^{b} is the binary output; and
αᵢ is a learnable coefficient controlling the threshold, wherein i denotes that the threshold can vary for different channels.

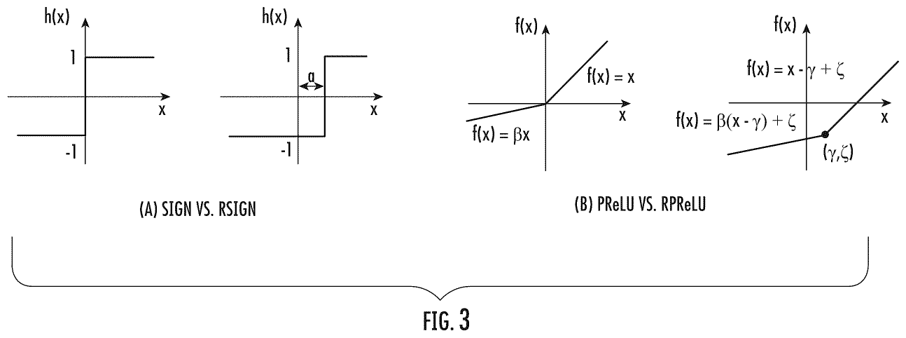

FIG. 3(a) compares the shapes of RSign and Sign.

Similarly, RPReLU is defined as:

$$f ( {x}_{i} ) = \{ \begin{matrix}{x}_{i} - {γ}_{i} + {ζ}_{i} , if {x}_{i} > {γ}_{i} \\ {β}_{i} ( {x}_{i} - {γ}_{i} ) + {ζ}_{i} , if {x}_{i} \leq {γ}_{i}\end{matrix} \qquad ( 4 )$$

where:
xᵢ is the input of the RPReLU function ƒ on the i^{th} channel;
γᵢ and ζᵢ are learnable shifts for moving the distribution; and
βᵢ is a learnable coefficient controlling the slope of the negative part of the distribution.

All of the coefficients can be different across channels. FIG. 3(b) compares the shapes of RPReLU and PReLU.

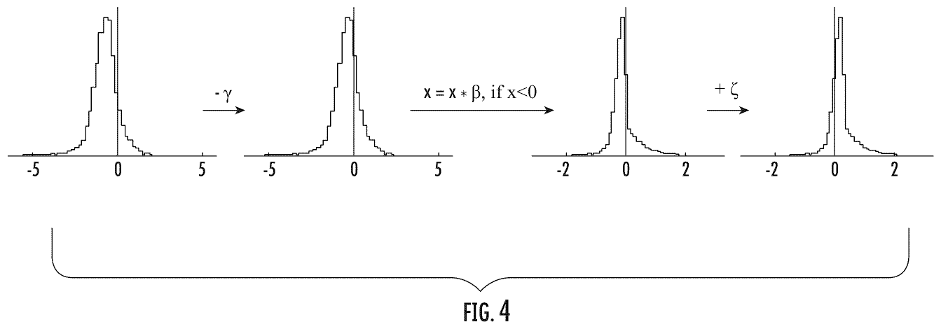

Intrinsically, RSign is learning the best channel-wise threshold (a) for binarizing the input feature map, or equivalently, shifting the input distribution to obtain the best distribution for taking a sign. From the latter angle, RPReLU can be easily interpreted as γ shifts the input distribution, finding a best point to use β to “fold” the distribution, then ζ shifts the output distribution. As illustrated in FIG. 4, RPReLU first moves the input distribution by −γ, then reshapes the negative part by multiplying it with β and, lastly, moves the output distribution by ζ. These learned coefficients automatically adjust activation distributions for obtaining good binary features, which enhances the performance of the 1-bit CNN. With the introduction of these functions, the aforementioned difficulty in distributional learning can be greatly alleviated, and the 1-bit convolutions can effectively focus on learning more meaningful patterns. This enhancement can boost the baseline networks top-1 accuracy substantially.

A ReActNet block is shown in FIG. 1(b), showing the ReAct-Sign and ReAct-PReLU added to the baseline network.

The number of extra parameters introduced by RSign and RPReLU is only the number of channels in the network, which is negligible considering the large size of the weight matrices. The computational overhead approximates a typical non-linear layer, which is also trivial compared to the computational intensive convolutional operations.

Optimization—Parameters in RSign and RPReLU can be optimized end-to-end with other parameters in the network. The gradient of αᵢ in RSign can be simply derived by the chain rule as:

$$\frac{δℒ}{{δα}_{i}} = {\sum }_{{x}_{i}^{r}} \frac{δℒ}{δ h ( {x}_{i}^{r} )} \frac{δ h ( {x}_{i}^{r} )}{δ {α}_{i}} \qquad ( 5 )$$

where:
[symbol] represents the loss function; and

$$\frac{δ h ( {x}_{i}^{r} )}{δ {α}_{i}}$$

denotes the gradients from deeper layers.

The summation is applied to all entries in the i^{th} channel. The derivative

$$\frac{δ h ( {x}_{i}^{r} )}{{δα}_{i}}$$

can be easily computed as:

$$\frac{δ h ( {x}_{i}^{r} )}{δ {α}_{i}} = - 1 \qquad ( 6 )$$

Similarly, for each parameter in RPReLU, the gradients are computed with the following formulae:

$$\frac{δ f ( {x}_{i} )}{δ {β}_{i}} = {I}_{\{ {x}_{i} \leq {γ}_{i} \}} \cdot ( x - {γ}_{i} ) \qquad ( 7 )$$

$$\frac{δ f ( {x}_{i} )}{δ {γ}_{i}} = - {I}_{\{ {x}_{i} \leq {γ}_{i} \}} \cdot {β}_{i} - {I}_{\{ {x}_{i} > {γ}_{i} \}} \qquad ( 8 )$$

$$\frac{δ f ( {x}_{i} )}{δ {ζ}_{i}} = 1 \qquad ( 9 )$$

Here, I denotes the indicator function I_{{⋅}}=1 when the inequation inside { } holds, otherwise I_{{⋅}}=0.

Distributional Loss—Because the binary neural networks can learn distributions similar to those of real-valued networks, the performance can be enhanced. A distributional loss to enforce this similarity, is formulated as:

$${ℒ}_{distribution} = - \frac{1}{n} {\sum }_{c} {\sum }_{i = 1}^{n} {p}_{c}^{{ℛ}_{θ}} ( {X}_{i} ) log ( \frac{{p}_{c}^{{β}_{θ}} ( {X}_{i} )}{{p}_{c}^{{ℛ}_{θ}} ( {X}_{i} )} ) \qquad ( 10 )$$

where:
[symbol] _{distribution} (the distributional loss) is defined as the KL divergence between the softmax output p c of a real-valued network [symbol] _{θ} and a binary network β_{θ}. The subscript c denotes classes and n is the batch size. The distributional loss yields competitive results. Moreover, without block-wise constraints, this method enjoys the flexibility in choosing the real-valued network without the requirement of architecture similarity between real and binary networks.

Herein were disclosed several novel ideas to optimize a 1-bit CNN for higher accuracy. First, parameter-free shortcuts were designed based on MobileNetV1 to propagate real-valued feature maps in both normal convolutional layers as well as the downsampling layers. Then, based on the observation that 1-bit CNNs performance is highly sensitive to distributional variations, ReAct-Sign and ReAct-PReLU were introduced to enable shift and re-shape the distributions in a learnable fashion and to demonstrate the dramatical enhancements on the top-1 accuracy. Additionally, the invention also incorporates a distributional loss, which is defined between the outputs of the binary network and the real-valued reference network, to replace the original cross-entropy loss for training.

As would be realized by one of skill in the art, the methods described herein can be implemented by a system comprising a processor and memory, storing software that, when executed by the processor, performs the functions comprising the method.

1. A method for improving performance of a binary neural network comprising:
replacing a normal block in a backbone of the binary neural network with a reduction block wherein depth-wise and point-wise convolutions of the normal block are replaced with generic convolutions in parallel with an identity shortcut using average pooling and input activations of the normal block are duplicated and outputs concatenated when a number of input and output channels of the normal block are unequal.

2. The method of claim 1 further comprising:
replacing binary activation functions with generalized activation functions having learnable coefficients in the normal block and the reduction block.

3. The method of claim 2 further comprising:
replacing the original cross-entropy loss for training with a distributional loss defined between outputs of the binary neural network and a real-valued reference network.

4. The method of claim 1 wherein the binary neural network backbone is MobileNet.

5. The method of claim 2 wherein the generalized activation functions comprise:
a generalized Sign activation function having channel-wise learnable thresholds; and
a generalized PReLU activation function having a distribution and one or more learnable shifts for moving the distribution and a learnable coefficient controlling a slope of a negative part of the distribution.

6. The method of claim 5 wherein the generalized Sign function:
learns a coefficient to shift an input distribution to obtain an optimal distribution for taking a sign.

7. The method of claim 5 wherein the generalized PReLU activation function:
learns a first coefficient to shift an input distribution;
learns a second coefficient used to fold the input distribution; and
learns a third coefficient to shift an output distribution;
wherein the learned coefficients adjust activation distributions to obtain binary features.

8. The method of claim 5 wherein the generalized Sign activation function is specified by:
$${x}_{i}^{b} = h ( {x}_{i}^{r} ) = \{ \begin{matrix}+ 1 , if {x}_{i}^{r} > {α}_{i} \\ - 1 , if {x}_{i}^{r} \leq {α}_{i}\end{matrix}$$
wherein xᵢ^{r} is a real-valued input of the function h on the i^{th} channel;
wherein xᵢ^{b} is the binary output;
wherein αᵢ is a learnable coefficient controlling the threshold, the threshold varying for different channels.

9. The method of claim 5 wherein the generalized PReLU activation function is specified by:
$$f ( {x}_{i} ) = \{ \begin{matrix}{x}_{i} - {γ}_{i} + {ζ}_{i} , if {x}_{i} > {γ}_{i} \\ {β}_{i} ( {x}_{i} - {γ}_{i} ) + {ζ}_{i} , if {x}_{i} \leq {γ}_{i}\end{matrix}$$
wherein xᵢ is the input of the function ƒ on the i^{th} channel;
wherein γᵢ ζᵢ and are learnable shifts for moving the distribution; and
wherein βᵢ is a learnable coefficient controlling a slope of a negative part of the distribution.

10. The method of claim 3 wherein the distribution loss is a KL divergence between the output of a real-valued reference network and the output of the binary neural network.

11. A system for improving performance of a binary neural network comprising:
a processor; and
memory storing software that, when executed by the processor, performs the function of:
replacing a normal block in a backbone of the binary neural network with a reduction block wherein depth-wise and point-wise convolutions of the normal block are replaced with generic convolutions in parallel with an identity shortcut using average pooling and input activations of the normal block are duplicated and outputs concatenated when input and output channel numbers of the normal block are unequal.

12. The system of claim 11 wherein the software performs the further function of:
replacing binary activation functions with generalized activation functions having learnable coefficients in the normal block and the reduction block.

13. The system of claim 12 wherein the software performs the further function of:
replacing the original cross-entropy loss for training with a distributional loss defined between outputs of the binary neural network and a real-valued reference network.

14. The system of claim 11 wherein the binary neural network backbone is MobileNet.

15. The system of claim 12 wherein the generalized activation functions comprise:
a generalized Sign activation function having channel-wise learnable thresholds; and
a generalized PReLU activation function having a distribution and one or more learnable shifts for moving the distribution and a learnable coefficient controlling a slope of a negative part of the distribution.

16. The system of claim 15 wherein the generalized Sign function:
learns a coefficient to shift an input distribution to obtain an optimal distribution for taking a sign.

17. The system of claim 15 wherein the generalized PReLU activation function:
learns a first coefficient to shift an input distribution;
learns a second coefficient used to fold the input distribution; and
learns a third coefficient to shift an output distribution;
wherein the learned coefficients adjust activation distributions to obtain binary features.

18. The system of claim 13 wherein the distribution loss is a KL divergence between the output of a real-valued reference network and the output of the binary neural network.
